(19) United States
(12) Patent Application Publication
(10) Pub. No.: US 2022/0162094 A1
(43) Pub. Date: May 26, 2022

(54) High performance electrocoagulation systems for removing water contaminants

(71) Applicant: The Regents of the University of California, Oakland, CA (US)

(72) Inventors: Ashok Jagannath Gadgil, Berkeley, CA (US); Arkadeep Kumar, Berkeley, CA (US); Mohit Nahata, Berkeley, CA (US); Siva Rama Satyam Bandaru, Berkeley, CA (US)

(73) Assignee: The Regents of the University of California, Oakland, CA (US)

(21) Appl. No.: 17/670,560

(22) Filed: Feb. 14, 2022

Related U.S. Application Data
(63) Continuation of application No. PCT/US20/46028, filed on Aug. 12, 2020.
(60) Provisional application No. 63/041,901, filed on Jun. 20, 2020.
(60) Provisional application No. 62/991,559, filed on Mar. 18, 2020.
(60) Provisional application No. 62/984,784, filed on Mar. 3, 2020.
(60) Provisional application No. 62/890,550, filed on Aug. 22, 2019.

(51) Int. Cl. C02F 1/463; C02F 1/461

(52) U.S. Cl. CPC C02F 1/463; C02F 2101/103; C02F 1/46109

(57) ABSTRACT

Iron electrocoagulation (Fe-EC) reactors for removing contaminants from water comprising an assembly of spiral-wound or folded iron-containing anode and cathode plates separated with perforated insulating spacers, or an oxidant to accelerate oxidation of Fe(II) ions released from the anode to obtain Fe(III) ions, and/or to oxidize the contaminant.

This invention was made with government support under Contract Numbers DE-IA0000018 and DE-AC02-05CH11231 awarded by the U.S. Department of Energy. The government has certain rights in the invention.

### INTRODUCTION

Iron based electrochemical technology such as iron electrocoagulation (Fe-EC) is a promising water treatment technology for removing arsenic, chromium, emerging organic contaminants of concern and other metals such as copper, manganese, nickel, cadmium, uranium, cobalt and lead.

### SUMMARY OF THE INVENTION

The invention provides methods, composition and systems for contaminant removal from water using iron-electrocoagulation.

In an aspect the invention provides a high performance iron electrocoagulation (Fe-EC) reactor for removing water contaminants or treating an aqueous solution to remove contaminants, comprising an assembly of spiral-wound or folded and inter-digited (e.g. pleated or accordion format) iron-containing anode and cathode plates separated with perforated insulating spacers.

In embodiments:

one or both plates comprise steel;

the reactor contains an oxidant, such as H₂O₂, O₃, chlorine, or permanganate;

the reactor contains contaminated water and an oxidant (such as H₂O, O₃, chlorine, or permanganate) to accelerate oxidation of Fe(II) ions released from the cathode plate to obtain Fe(III) ions, and/or to oxidize one or more other contaminants in the water;

the reactor is contained in a tank wherein the plates are electrically connected to a DC voltage source, a DC voltage exists between the plates, the reactor contains contaminated water and Fe(II) ions released from the F(0) of the plates;

the reactor is contained in a cylindrical tank, of circular cross-section for the spiral wound reactor, and of corresponding cross-section for the folded plates reactor;

the tank has an inlet or inlets and an outlet or outlets, configured in a flow path to flow contaminated water through the inlet or inlets, pass through the space between the plates, and exit the tank from the outlet or outlets;

the contaminated water is non-stationary within the tank, and in motion or flowing;

the reactor comprises a perforated insulating sheet or mesh separator disposed between the plates;

the reactor comprises 4-layer, spiral-wound assembly of electrode plate, first perforated insulating sheet or mesh separator, opposite electrode plate, second perforated insulating sheet or mesh separator,

In an aspect the invention provides a method of using a disclosed reactor, comprising applying a DC voltage between the plates to promote anodic dissolution of F(0) metal to release Fe(II) ions into the contaminated water.

In embodiments:

the method further comprises the step of replacing one or both of the plates or replacing the assembly after one or both of the plates is consumed to near (20%, 30%, 40%, 50%, 60%, 70%, 80%, 90%, 100%) exhaustion;

the method further comprises the step of tracking changes in voltage and/or current over time to monitor the degradation of electrode plates, thus identifying the optimal point for electrode replacement, and/or

the separating step comprises separating the contaminated water or aqueous solution comprising the Fe(III) precipitates or Fe(II)-Fe(III) precipitates or Iron(III)(oxyhydr)oxides using a separation technique (such as filtration, coagulation, flocculation, settling or any combination of these techniques) to achieve clearer water.

The invention provides methods, composition and systems for arsenic removal from water using iron-electrocoagulation.

In an aspect the invention provides a method for arsenic removal from water comprising: (a) flowing arsenic-contaminated water through an iron electrocoagulation (FeEC) reactor comprising an anode and a cathode, and (b) applying a DC voltage between the anode and cathode to promote anodic dissolution of Fe(0) metal to release Fe(II) ions into the contaminated water, wherein the reactor contains an oxidant (such as H₂O₂, O₃, chlorine, dichromate or permanganate) to accelerate oxidation of Fe(II) ions released from the anode to obtain Fe(III) ions, and/or to oxidize arsenic in the water, to lead to conditions wherein the arsenic is removed from the water in the reactor.

In embodiments:

the method achieves effective removal of arsenic from its initial level by about 100 fold or more, such as from about 300 μg/L to less than 3 μg/L, or even from about 1000 μg/L to less than 10 μg/L, e.g. 200-2,000 to less than 2-20 ug/L;

the method uses a flow rate at least or about 2 or 3 or 4 times the reactor volume per minute, or a range of about 2 or 3 or 4 to about 4 or 6 or 8 times the reactor volume per minute, e.g., when flowing water through a reactor volume of 0.5 liters, we achieved this removal in 15 seconds, giving a flow rate of 4 times the reactor volume per minute;

the method uses high current density of at least or about 2.5, 5, 10, 20, 40, 80 or 200 mA/cm square or a range of 20 or 40 or 80 to 80 or 120 or 200 mA/cm square;

the oxidant (e.g. H₂O₂) is generated in-situ, or can be added exogenously;

the reactor is contained in an enclosure with one or more inlets, and one or more outlets wherein: the enclosure contains the cathode and anode; the contaminated water enters the enclosure through the inlet(s), and exits the enclosure through the outlet(s), the anode and cathode are electrically connected to a DC voltage source, so a DC voltage exists between the anode and cathode, the reactor contains contaminated water and Fe(II) ions released from the Fe(0) of the anode;

the enclosure is a cylindrical tank, of circular cross-section for the spiral wound reactor, and of corresponding cross-section for the folded plates reactor,

the tank has an inlet or inlets and an outlet or outlets, configured in a flow path to flow contaminated water through the inlet or inlets, pass through the space between the anode and cathode, and exit the tank from the outlet or outlets;

the reactor comprises a perforated insulating sheet or mesh separator disposed between the anode and cathode;

the reactor comprises a 4-layer, spiral-wound assembly of electrode plate, first perforated insulating sheet or mesh separator, opposite electrode plate, second perforated insulating sheet or mesh separator,

the anode and cathode are provided as two parallel plates of low-carbon steel material;

or the reactor is an air-cathode assisted iron-electrocoagulation (ACAIE) reactor, operated at high current density, with the reactor comprising an air-diffusion cathode and optionally, a low-carbon steel plate anode, or non-active anodes (e.g., mix-metal-oxide anode).;

or the reactor is a high-performance iron electrocoagulation (Fe-EC) reactor comprising an assembly of spiral-wound or folded and inter-digited (e.g. pleated or accordion format) iron-containing anode and cathode plates separated with perforated insulating spacers;

the reactor comprises a perforated insulating sheet or mesh separator disposed between the plates;

the reactor comprises a 4-layer, spiral-wound assembly of electrode plate, first perforated insulating sheet or mesh separator, opposite electrode plate, second perforated insulating sheet or mesh separator,

the method further comprises the step of replacing one or both of the anode and cathode or replacing the assembly after one or both of the plates is consumed to near (20%, 30%, 40%, 50%, 60%, 70%, 80%, 90%, 100%) exhaustion;

the method further comprises the step of tracking changes in voltage and/or current over time to monitor the degradation of an electrode, thus identifying the optimal point for electrode replacement; and/or

the separating step comprises separating the post-reactor-outlet water or aqueous solution comprising the Fe(III) precipitates or Fe(II)-Fe(III) precipitates or Iron(III)(oxyhydr)oxides, using a separation technique (such as filtration, coagulation, flocculation, settling or any combination of these techniques) to achieve treated water with low turbidity.

In an aspect the invention provides an iron electrocoagulation (Fe-EC) reactor configured for a disclosed method.

In embodiments:

In one embodiment the reactor is configured to generate the oxidant (e.g. H₂O₂) in-situ, or has an attached air-cathode unit that generates H₂O₂ on-site for injection into the inlet water,

the reactor is contained in a tank comprising an inlet or inlets and an outlet or outlets, configured in a flow path to flow contaminated water through the inlet or inlets, pass through the space between the plates, and exit the tank from the outlet or outlets, wherein: the plates are electrically connected to a DC voltage source, a DC voltage exists between the plates, and the reactor contains contaminated water and Fe(II) ions released from the Fe(0) of the plates, and a dilute concentration of a chemical oxidant (such as H₂O₂); or

the reactor is an air-cathode assisted iron-electrocoagulation (ACAIE) reactor comprising a carbon-based air-diffusion cathode and optionally, a low-carbon steel plate anode; or the reactor is a high performance iron electrocoagulation (Fe-EC) reactor comprising an assembly of spiral-wound or folded and inter-digited (e.g. pleated or accordion format) iron-containing anode and cathode plates separated with perforated insulating spacers, and contained in a cylindrical tank, of circular cross-section for the spiral wound reactor, and of corresponding cross-section for the folded plates reactor.

In embodiments we integrate air-cathode assisted iron electrocoagulation (ACAIE) to locally generate H₂O₂. In an aspect the invention provides a two chamber-design for air-cathode assisted Fe-EC. This design (see, FIG. 3) can be configured to prevent iron oxide particles from attaching to air-cathode, making the life-time of the process longer. An embodiment of the two-chamber design comprises a first chamber having air-cathode, and non-active (e.g. titanium/mixed metal oxide) anode, with a clean water inlet and outlet of H₂O₂-enriched water. The H₂O enriched water feeds into the 2nd chamber, with both anode and cathode as iron. H₂O₂ is generated on-spot, and externally added, yet air-cathode stays away from Fe-particles and does not get fouled. Such on-spot in-situ H₂O₂ generation is useful when industrially produced oxidants may be difficult to transport, or to remote regions where arsenic and/or silica removal is a particularly serious problem.

The invention provides methods, composition and systems for silica removal from water using iron-electrocoagulation.

In an aspect the invention provides a method for silica removal from water comprising: (a) flowing silica-contaminated water through an iron electrocoagulation (Fe-EC) reactor comprising an anode and a cathode, and (b) applying a DC voltage between the anode and cathode to promote anodic dissolution of F(0) metal to release Fe(II) ions into the contaminated water, wherein the reactor contains an oxidant (such as H₂O₂, O₃, chlorine, or permanganate) to accelerate oxidation of Fe(II) ions released from the anode to obtain Fe(III) ions, under conditions wherein the silica is removed from the water in the reactor.

In embodiments:

the method achieves effective removal of silica from initial level of at least about 5 or 10 fold, such as from 100-500 mg/L to 20-100 or 10-50 mg/L, e.g. 350 mg/L to 30 mg/L;

the method uses a flow rate at least or about 2 or 3 or 4 times the reactor volume per minute, or a range of about 2 or 3 or 4 to about 4 or 6 or 8 times the reactor volume per minute, e.g. in a reactor size of 0.5 liters we achieved this removal in 15 seconds, giving a flow rate of 4 times the reactor volume per minute.;

the method uses high current density of at least or about 20, 40, 80 or 200 mA/cm square or a range of 20 or 40 or 80 to 80 or 120 or 200 mA/cm square;

the oxidant (e.g. H₂O₂) is generated in-situ, or added exogenously;

the reactor is contained in a tank wherein: the anode and cathode are electrically connected to a DC voltage source, a DC voltage exists between the anode and cathode, and the reactor contains contaminated water and Fe(II) ions released from the F(0) of the anode;

the reactor is the contained in a cylindrical tank, of circular cross-section for the spiral wound reactor, and of corresponding cross-section for the folded plates reactor;

the tank has an inlet or inlets and an outlet or outlets, configured in a flow path to flow contaminated water through the inlet or inlets, pass through the space between the anode and cathode, and exit the tank from the outlet or outlets;

the reactor comprises a perforated insulating sheet or mesh separator disposed between the anode and cathode;

the reactor comprises a 4-layer, spiral-wound assembly of electrode plate, first perforated insulating sheet or mesh separator, opposite electrode plate, second perforated insulating sheet or mesh separator,

the anode and cathode are provided as two parallel plates of low-carbon steel material;

the reactor is an air-cathode assisted iron-electrocoagulation (ACAIE) reactor comprising a carbon-based air-diffusion cathode and optionally, a low-carbon steel plate anode;

the reactor is a high performance iron electrocoagulation (Fe-EC) reactor comprising an assembly of spiral-wound or folded and inter-digited (e.g. pleated or accordion format) iron-containing anode and cathode plates separated with perforated insulating spacers;

the reactor comprises a perforated insulating sheet or mesh separator disposed between the plates;

the reactor comprises a 4-layer, spiral-wound assembly of electrode plate, first perforated insulating sheet or mesh separator, opposite electrode plate, second perforated insulating sheet or mesh separator,

the method further comprises the step of replacing one or both of the anode and cathode or replacing the assembly after one or both of the plates is consumed to near (20%, 30%, 40%, 50%, 60%, 70%, 80%, 90%, 100%) exhaustion;

the method further comprises the step of tracking changes in voltage and/or current over time to monitor the degradation of an electrode, thus identifying the optimal point for electrode replacement; and/or

the separating step comprises separating the contaminated water or aqueous solution comprising the Fe(III) precipitates or Fe(II)-Fe(III) precipitates or Iron(III)(oxyhydr)oxides using a separation technique (such as filtration, coagulation, flocculation, settling or any combination of these techniques) to achieve clearer water.

In an aspect the invention provides an iron electrocoagulation (Fe-EC) reactor configured for a disclosed method.

In embodiments:

the reactor is configured to generate the oxidant (e.g. H₂O₂) in-situ;

the reactor is contained in a tank comprising an inlet or inlets and an outlet or outlets, configured in a flow path to flow contaminated water through the inlet or inlets, pass through the space between the plates, and exit the tank from the outlet or outlets, wherein: the plates are electrically connected to a DC voltage source, a DC voltage exists between the plates, and the reactor contains contaminated water and Fe(II) ions released from the F(0) of the plates.

the reactor is an air-cathode assisted iron-electrocoagulation (ACAIE) reactor comprising a carbon-based air-diffusion cathode and optionally, a low-carbon steel plate anode; or the reactor is a high performance iron electrocoagulation (Fe-EC) reactor comprising an assembly of spiral-wound or folded and inter-digited (e.g. pleated or accordion format) iron-containing anode and cathode plates separated with perforated insulating spacers, and contained in a cylindrical tank, of circular cross-section for the spiral wound reactor, and of corresponding cross-section for the folded plates reactor.

The invention encompasses all combinations of the particular embodiments recited herein, as if each combination had been laboriously recited.

### BRIEF DESCRIPTION OF THE DRAWINGS

FIGS. 1A and 1B. Side and top views of the spiral FeEC reactor; arrow shows the flow direction.

FIG. 2. Section of the pleated or folded FeEC reactor, flow direction is perpendicular to plane shown; only three loops are shown, whereas actual design comprises flow paths replicated and/or stacked.

FIG. 3. Two-chamber design with first chamber generating oxidizer on spot, feeding to second chamber for contaminant removal.

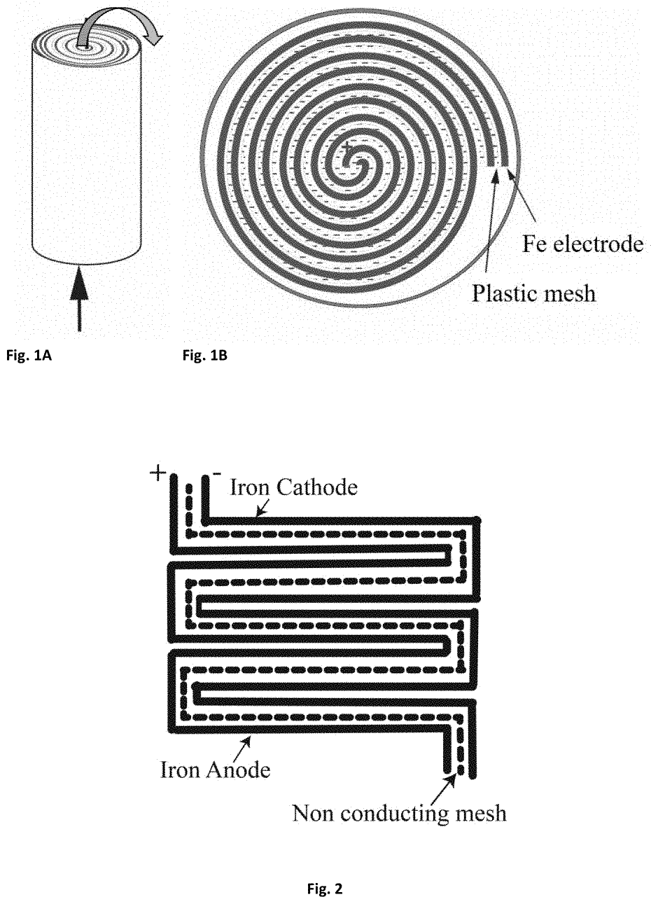

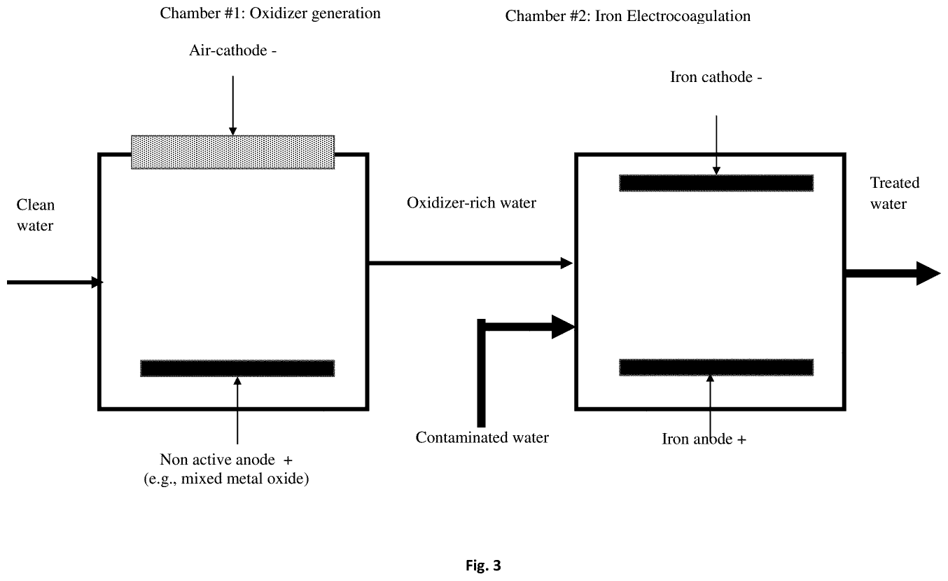

### DESCRIPTION OF PARTICULAR EMBODIMENTS OF THE INVENTION

Unless contraindicated or noted otherwise, in these descriptions and throughout this specification, the terms “a” and “an” mean one or more, the term “or” means and/or. The examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein, including citations therein, are hereby incorporated by reference in their entirety for all purposes.

I. High Performance Iron Electrocoagulation Systems for Removing Water Contaminants

In one aspect the reactor comprises assembly of spiral-wound two or more steel sheets separated with perforated insulating spacers is placed in a cylindrical tank. If the assembly is folded, it can be of any cross-section, and the tank will have an appropriate shape. By way of example we describe the spiral-wound approach, but the same principles apply to folded approach. Our approach achieves very high area to volume (AV) ratios for a given electrode spacing. A substantial reduction in the energy consumption results from extremely small inter electrode separation, and a small footprint results from overall compactness. Our approach allows Fe-EC systems to operate at shorter retention times (˜seconds) to achieve larger flow rates for a given reactor size, than the convention Fe-EC systems based on standard inter-digited flat plate configuration. Our approach allows smaller footprint (by an order of magnitude), in comparison to conventional Fe-EC systems.

In an embodiment we replace the assembly of inter-digited flat steel plates with an assembly of spiral-wound or folded and inter-digited (e.g. pleated or accordion format) two steel sheets separated only with perforated insulating spacers. This substantially reduces the energy consumption, and allows for large flow rates for a given reactor size than the standard inter-digited flat plate configuration. This advance is facilitated with externally added (ppm quantities) of oxidizer (H₂O₂), and an effect that allows consistent iron dissolution at high current densities. High current density also produces copious quantities of micro-bubbles of H₂ gas which flushes the space between the electrodes continuously during operation, preventing clogging that has defeated earlier attempts. In those applications where Fe(III)(oxyhydr)oxides are required, in this approach we add a small amount of an external oxidant (e.g., 10-100 ppm (mg/L) of H₂O₂ with a peristaltic pump) before the contaminated water enters the reactor.

Some features of this design include: low potential drop across the electrode plates—this translates directly to about 2, 5, 10 or 20 times reduction in electrical energy; the operating voltages to drive the electrolytic processes can remain low, such as about or below 60, 30, 24 or 12 V thus increase safety in case of electrical exposure of plant workers; small footprint, about 2×, 5× or 10× smaller, in comparison to conventional Fe-EC systems; the electrode plates can be fully consumed during the process without wastage; during the electrolytic process, hydrogen bubbles form on the cathode in amounts sufficient to aid in efficient mixing and flushing of the solution; hydrogen gas can be recovered to generate energy, or for other chemical process use; and the residual oxidant (e.g. H₂O₂) can be used for additional advanced treatment by combining with UV.

Practical applications of the invention include are community and municipal scale drinking water treatments, community and municipal scale recycling and reuse of wastewater treated effluent, industrial wastewater treatment (e.g., ash pond, silicate removal from produced water from oil and gas industry). Commercial applications include removal and capture of: arsenic, emerging organic contaminants of concern (e.g., pharmaceuticals, organic pesticides), ions of other metals such as copper, manganese, nickel, cadmium, uranium, cobalt, and lead, phosphate, silicate (e.g. silicate minerals, ionic solids with silicate anions; as well as rock types that consist predominantly of such minerals, such as the non-ionic compound silicon dioxide SiO₂ (e.g. silica, quartz)), hexavalent chromium (this uses the same reactor design, but without adding external oxidizer). Fe-EC systems employing our invention can directly replace arsenic treatment technologies in USA, India, Bangladesh, China and other arsenic affected regions in the world. For example, our invention can replace the ECAR technology in India for treating arsenic contaminated in India. The invention is also useful in oil and gas industries, such as for pre-treatment of produced water to remove dissolved silicate, and for coal-fired thermal power plants to treat arsenic from their ash-pond water, and for ex-situ remediation of hexa-valent chromium from contaminated aquifers.

II. Silica Removal from Water Using Iron-Electrocoaguladon

High levels of dissolved silica (SiO₂) is commonly present in groundwater including produced water from oil and gas extractions. The high silica level in such waters (e.g., Produced Water) present a problem in treatment of wastewater in any membrane processes (e.g. RO, UF, electrodialysis ED, Forward osmosis, etc). Hence highly efficient effective removal of silica at high flow rates is required by industry as pre-treatment before subsequent membrane processes.

Prior state of the art for silica removal from produced water is using chemical coagulants (e.g. magnesium oxide MgO, FeCl₃), which is costly, not environmentally friendly, and requires supply-chain. Alternate electrochemical methods are based on Al-EC and Fe-EC. However, these suffer from low flow rates and large footprint. For oil and gas industry, treatment rates of 40,000 cubic meters water per well per day is commonly required.

We have devised and demonstrated an iron electrocoagulation (Fe-EC) technology using external addition of H₂O₂ or in-situ generated H₂O₂, that can remove high levels of dissolved silica. We demonstrated effective removal of silica from initial level of at least 5 or 10 fold, such as from 100-500 mg/L to 20-100 or 10-50 mg/L, e.g. 350 mg/L to 30 mg/L. We demonstrated flow rates of 2, 3 and 4 times the reactor volume per minute, e.g. in a reactor size of 0.5 liters we achieved this removal in 15 seconds, giving a flow rate of 4 times the reactor volume per minute. This is unprecedented, and of great utility to oil and gas industry. This was achieved using high current density of at least or about 20, 40, 80 or 200 mA/cm square.

Hence, we disclose a practical approach for iron-electrocoagulation that removes dissolved silica from synthetic produced water effectively in short electrolysis times, demonstrating that it is possible to remove silica with low retention times and high throughput.

In an embodiment we disclose efficiency of electrocoagulation to process large volumes of water using air-cathode assisted iron electrocoagulation (ACAIE), which we developed from our ACAIE arsenic reactor design, see: Bandaru, et al., American Geophysical Union, Fall Meeting, San Francisco, Calif. Dec. 9-13, 2019: GH23B-1228—An extremely rapid and efficient engineered system to remove arsenic in the groundwater used for drinking. The reactor uses air-diffusion cathodes, where fully oxidized Fe(III) oxides are more efficient in silica removal at high throughput using large charge dosage rates (C/L/min), henceforth referred to as CDR. In another embodiment we use a high-performance iron electrocoagulation (Fe-EC) reactor comprising an assembly of spiral-wound or folded and inter-digited (e.g. pleated or accordion format) iron-containing anode and cathode plates separated with perforated insulating spacers.

### Example: Removing Dissolved Silica from Produced Water with Iron-Electrocoagulation at High Throughput as Pre-Treatment to Prevent Fouling of Membranes

In this example we show a new method of iron electrocoagulation with air-diffusion cathode to remove silica at high throughput, which is required for large volumes of produced water (wastewater from petroleum extraction)—as a pre-treatment to prevent fouling of membranes (in reverse osmosis) which is the standard final step in produced water treatment, before re-use or discharge into the environment.

Desalination of inland waste brackish water is being considered as a new source of water to meet demands of fresh water. One such source is the byproduct of petroleum extraction from deep aquifers, called produced water, often in quantities of 40,000 cubic meters per oil-well per day. Large volumes of high salinity water undergo treatment by a series of processes involving reverse osmosis (RO) before re-use or discharge into the environment. Unfortunately, high amounts of dissolved silica (˜300 mg/L) foul the membranes involved and restrict water recovery from the RO. Fouling increases the pressure and energy requirements, as well as the cost of cleaning and replacing the membranes. Here, we investigate the efficiency of iron-electrocoagulation (Fe-EC) as a potential pre-treatment method to remove silica at the high throughput volumes necessary for produced water. Conventional Fe-EC is rate-limited with the amount dissolved oxygen required to oxidize Fe(II) to Fe(III), and generates mixed valent Fe-oxides at high charge dosage rates. We present an improved Fe-EC with air-diffusion cathode, which generates in-situ hydrogen peroxide as a stronger oxidant than dissolved oxygen, improving the formation of completely oxidized Fe (oxyhydr)oxides as sorbents for silica removal. Exemplified with the Air-Cathode Assisted Iron Electrocoagulation (ACAIE), fully oxidized Fe(III) oxides are more efficient than mixed valent Fe-oxides, in removing silica at high throughput using large charge dosage rates (C/L/min). We report that silica removal is dependent on charge dosage rate (of iron coming into solution from the sacrificial anode) and the total iron dose, over characteristic pH ranges in synthetic produced water. Our disclosure enables iron-electrocoagulation for silica removal in large-scale inland brackish water treatment.

Electrolysis Reactors

All experiments were conducted at room temperature using open-air batch reactors. Iron-Electrocoagulation (Fe-EC) experiments were conducted in a 500 ml cylindrical beaker, with the anode and cathode as two parallel plates of low-carbon steel material (purchased from McMaster-Carr) immersed into the electrolyte. The electrodes were separated with 2.5 cm (1 inch) thick non-conducting spacer. The submerged surface area of the steel anode was 49 cm² (7 cm×7 cm). To ensure same conditions of the plates for each experiment, the plates were polished with grit 240 sandpaper till shiny appearance, and cleaned thoroughly with deionized water before the experiments. The air-cathode assisted iron-electrocoagulation (ACAIE) experiments were conducted in 500 ml rectangular channel reactor, with one side of the reactor having carbon-based air-diffusion cathode. A rectangular low-carbon steel plate served as the anode and was placed parallel to the air-cathode. The effective area of the air-cathode was 64 cm² (8 cm×8 cm), and the submerged area of the anode was kept 49 cm² (7 cm×7 cm). The spacing between the electrodes was kept constant for all experiments in both Fe-EC and ACAIE and equal to 2.5 mm. An external DC power supply was used in galvanostatic mode to supply current in both setups over a range of current and voltages. We specified the current based on the charge dosage rates and allowed the voltage to vary over the course of the experiment. Each experiment was repeated three times to account for errors in experimentation. Error bars in results represent standard deviation. The initial silica level was 300 mg/L with final target silica level of less than 100 mg/L, as the saturation limit of silica at circumneutral pH and room temperature is around 100-120 mg/L [6].

Electrolyte and Measurement Methods

Lab-scale experiments were performed using batches of high-silica synthetic produced water. The composition of the electrolyte used in the experiment was taken from literature on high silica wastewater from oil and gas extraction [18]. We mixed DI water (Millipore Sigma) with 2000 mg/L NaCl, 50 mg/L Na₂SO₄, 50 mg/L CaCL₂, 20 mg/L MgCl₂, 1500 mg/L NaHCO₃, and 300 mg/L Na₂SiO₃ for high-silica content. All experiments were performed with reagent grade chemicals (Sigma-Aldrich and Alfa-Aesar). The composition of the synthetic high silica produced water used in experiments is shown in Table 1. In produced water treatment, the initial steps of clarification, walnut shell filters and other processes reported in literature remove the hydrocarbons [19, 20]. Reverse osmosis membranes are used for the final desalination steps, and face challenges of fouling by dissolved silica—which is our research focus. Hence, we did not use hydrocarbons in the composition of the water requiring silica removal before RO. Initial pH of the electrolyte was controlled by bubbling CO₂ gas, and using small amount of 1 M NaOH or 1.1 M HCl.

TABLE 1
Composition of synthetic produced water used in our experiments.

| | Molecular weight | mg/L | mM |
|---|---|---|---|
| NaHCO₃ | 61.01 | 1500 | 24.59 |
| CaCl₂ | 40.08 | 50 | 1.25 |
| MgCl₂ | 24.30 | 20 | 0.82 |
| Na₂SiO₃ | 28.06 | 300 | 10.69 |
| Na₂SO₄ | 96.06 | 50 | 0.52 |
| NaCl | 35.5 | 2000 | 56.34 |

In all experiments, the electrolyte was continuously stirred with a magnetic stir bar and the reactor placed on a stir-plate at 500 rpm. At the end of each electrolysis experiment, filtered (through 0.45 μm nylon filter) and unfiltered samples were collected to measure the “dissolved” concentration and initial concentration of silica respectively. Fe concentrations in unfiltered samples was measured to confirm the Faradaic efficiency of the Fe coming into the solution from the anode.

Inductively Coupled Plasma Optical Emission Spectroscopy (ICP-OES by Perkin-Elmer 5300 DV) was used to find the concentrations of the silica and iron in water samples. In each experiment, initial and final values of pH, conductivity and dissolved oxygen (DO) was measured using sensors from Thermo Scientific (Orion Star A 329 meter). To note, freshly prepared silica-rich synthetic produced water was used for all experiments to prevent any possible precipitation of silica. Hence, all removal of silica is attributed to the iron-electrocoagulation process and not to any self-precipitation due to supersaturation.

XRD Measurements

To find the structure of iron-oxides in the two methods of ACAIE and Fe-EC, x-ray diffraction (XRD) measurements were made on the Fe-oxide precipitates collected on 0.1 um filter using vacuum pump according to previously published methods [21]. The filtered samples were dried and ground into powder using mortar and pestle, before putting on a silicon wafer substrate for XRD analysis. XRD of the Fe(III) precipitates was collected using a Bruker D8 Discover GADDS X-ray diffractometer. We used the XRD with Co-source with Co-Kα wavelength of 1.79 Å. We collected data over 5° to 95° 2θ, over 4 frames, starting with each θ₁=10° and θ₂=10°, frame width=20°, with coupled scan axis. Total data collection time was 2 hour per sample. Oxidation of green rust (mixed valent Fe oxides) samples was prevented by putting a small amount of glycerol on the samples at high-dosage rates. The XRD patterns are known to be same with and without glycerol as per prior literature [21]. The XRD instrument was calibrated to known standards. We reported the diffractograms normalized by the highest intensity peak to compare among samples with different crystallinity. The Fe oxide precipitates for XRD characterization were collected using an electrolyte without silica, to avoid any confounding effect of silica absorption on the Fe(III). Hence, an electrolyte of 5 mM NaCl and 5 mM NaHCO3 at pH 7 was used for the XRD samples.

Additional experiments were conducted in triplicate to test the hypothesis of silica being removed by iron-oxides through co-precipitation and adsorption on the high sorbent Fe-oxides, versus negatively charged silica migrating to the positive charged anode. Both electrodes in Fe-EC and the iron anode in ACAIE were dipped in concentrated HCl solution for five minutes to ensure that all surface layers on the electrodes were washed with acid. The resulting sample was analyzed using ICP-OES to determine the fraction of silica going to the electrode. The mass balance was conducted between the amount of silica found on the iron electrodes, and the amount of silica in unfiltered solution, to compare with the initial level of silica.

We conducted three types of experiments to test the feasibility of iron-electrocoagulation:

Comparing Fe-EC and ACAIE for removal of silica over pH ranges generally found in produced water [18, 20], with retention time of 3.33 minutes (charge dosage rate of 60 C/L/min and total dose of iron being 200 C/L). The retention time was chosen based on practical limits for handling large volumes of produced water in real-field applications. The initial pH in experiments was adjusted using strong acid or base solutions.

Comparing Fe-EC and ACAIE for removal of silica at two charge dosage rates of 3 C/L/min and 60 C/L/min with total dose of 200 C/L in each case. The retention times were 66.66 minutes and 3.33 minutes respectively.

Finding the effect of charge dosage rates in removing silica, comparing between the rates of 60 C/L/min and 600 C/L/min, with corresponding higher and lower retention times, and measuring the silica level remaining in solution with increasing total dose from 100 C/L till 3000 C/L. This experiment provides practical knowhow useful for translating technology from lab to the field.

Fabrication of the Air-Cathode

The air-cathode was prepared using prior procedures reported in literature [22] and adapted to our experiments. In short, the carbon fiber paper (AvCarb P75T, 10 cm×10 cm Fuel Cell store, College Station, Tex.) was coated with a carbon catalyst layer on the water side, and hydrophobic, conductive graphite platelets support layer on the air side. The water side was prepared using carbon black (Cabot Black Pearls 2000, Cabot, Boston, Mass.), mixed with 1-propanol as solvent and PTFE as the binder. After applying the mixture on the carbon fiber paper, the cathode was air-dried in room temperature for 20 minutes and next sintered in an oven for 40 minutes at 350° C. temperature. The air-side was prepared by painting a mixture of graphite powder (200 mesh, Alfa Aesar, Ward Hill, Mass.), mixed with 1-propanol and PTFE binder. Next, the cathode is air-dried for 20 minutes and sintered in the oven for 40 minutes at 350° C., to have the final air-diffusion cathode. We used the same air-cathode for all experiments, rinsing 3 times with DI water between each experiment to maintain same initial conditions.

Comparison of Fe-EC and ACAIE Across Different pH Levels

We compared silica removal by Fe-EC and ACAIE at different pH levels of 6.4, 7, and 8. The pH levels were chosen to represent typical pH of produced water found across different regions.[4, 12, 18, 20]. The solution after treatment was filtered through 0.45 μm nylon filters, removing the silica attached to iron particles. The silica remaining dissolved in solution after filtration was measured using ICP-OES. All the experiments were at 60 C/L/min dosage rates and 200 C/L total iron dose, with a retention time of 3.33 minutes. The experiment aimed to remove dissolved silica from initial level of 300 mg/L to final level of 100 mg/L, which is the target for pre-treatment of silica rich water from saturation limit at pH 7 and 25° C. Both devices were effective at removal silica at tested pH, with ACAIE performing better than Fe-EC in the typical pH range of produced water.

Comparison of Fe-EC and ACAIE at Different Retention Times

Next, we compared silica removal by Fe-EC and ACAIE at two different retention times of 3.33 minutes and 66.66 minutes. The silica remaining dissolved in solution after treatment was measured by ICP-OES. Both devices were effective at removal silica at tested retention time, wherein ACAIE removes silica more effectively than Fe-EC using the same electrolysis or retention times. At shorter retention times, which is most practical when treating large volumes of produced water, the difference between ACAIE and Fe-EC is larger. All the experiments were at 200 C/L total iron dose or charge dose (CD). The retention times of 66 minutes and 3 minutes correspond to CDR 3 and 6 C/L/min respectively.

Effect of Charge Dosage Rates in Fe-EC and ACAIE to Design the Treatment Process

The effect of CDR is critical for designing and improving produced water treatment, and calculating treatment times. We compared two CDRs 60 and 600 C/L/min, by measuring the silica remaining dissolved in the solution with increasing total dose or charge dose (CD) in ACAIE. Results show that the difference in silica removal is not significant between 60 and 600 C/L/min dosage rates. Dissolved silica is reduced from 300 mg/L to less than 100 mg/L at about 100 C/L CD or total Fe dose. For higher water recovery from RO, lower silica content (50-30 mg/L) is required. Such low levels of dissolved silica remaining is achieved at higher CD of (1500 C/L iron).

Effect of Charge Dosage Rates on Silica Removal in Fe-EC

We determined the effect of charge dosage rate for Fe-EC. The results show best removal of silica at 300 C/L/min, better than low dosage rates of 60 C/L/min or higher dosage rates of 600 C/L/min or 12 C/L/min. The possible hypothesis is that undesirable reactions taking place at very high dosage rates such as 600 and 1200 C/L/min. To note that the target value<100 mg/L achieved with 500-1000 C/L dose of iron. Also, incomplete oxidation of Fe(II) oxides at high charge dosage rates produces green rust and inefficient in removing silica. This is the problem of Fe-EC overcome by hydrogen peroxide produced for ACAIE at the air-cathode.

XRD of Iron Oxides in Fe-EC and ACAIE

We conducted XRD to investigate the structure of iron oxides in conventional Fe-EC and ACAIE. We compared the XRD diffractograms of Fe-EC vs ACAIE at two charge dosage rates of 3 and 60 C/L/min. The diffractograms showed the characteristic Bragg diffraction peaks found in Fe-oxide systems [23-26]. Fe-EC at low CDR 3 C/L/min showed lepidocrocite (L) peaks, while increasing the CDR to 60 C/L/min showed carbonate green rust (GR). Green rust was confirmed by high intensity peaks at 20 values of 12° and 24° approximately, found in prior literature [27]. ACAIE at low CDR 3 C/L/min shows lepidocrocite. With increase in CDR to 60 C/L/min ACAIE shows reduction in lepidocrocite peaks, and emergence of 2-line ferrihydrite peaks (Fh). However, ACAIE at 60 C/L/min did not show evidence of green rust peaks, which were present in Fe-EC at 60 C/L/min. Moreover, visual inspection showed green-blue colored precipitates in Fe-EC at 60 C/L/min, versus brown-orange colored precipitates in ACAIE. ACAIE showed broader peaks of lepidocrocite than Fe-EC for the same CDR, (e.g. 3 C/L/min). Secondly, higher CDR diffractograms showed peak broadening which is characteristic of smaller size of crystalline particles, consistent with the higher rate of reactions.

Thus, we found broadening of peaks as a trend for two cases: (1) from Fe-EC to ACAIE (2) from low to high CDR. We hypothesize with faster reactions in presence of in-situ H₂O₂ produced in ACAIE, and with higher charge dose rates (equivalent of increasing rates of iron coming into the solution), there is less time for Fe-oxides to form well-crystallized structures, leading to poorly crystalline precipitates in ACAIE (and hence peak broadening), compared to more crystalline precipitates in Fe-EC.

We used the electrolyte without silica to obtain sufficient crystallinity of the resulting Fe-oxides for analysis by x-ray diffraction (7.5 mM NaCl and 7.5 mM NaHCO₃, pH 7, dissolved oxygen level 3 mg/l, total Fe dose is 3.1 mM. We report the data normalized by the highest sample peak, to facilitate comparison between diffractograms with differing crystallinity. XRD data of Fe-oxides from Fe-EC at 60 C/L/min results are reported in another paper, and reproduced here for completeness of the data [cite paper in submission]. The key take-away from comparing the XRD diffractograms of Fe-EC vs. ACAIE is an increase in dosage rates using Fe-EC shows green rust peaks, whereas ACAIE shows ferrihydrite peaks, and does not form green rust. The removal of Si is worse by Fe-EC at 60 C/L/min than 3 C/L/min, which we hypothesize is due to green rust. Mixed valent Fe(III)-Fe(II) oxides are not as efficient in binding to aqueous silica and removing the dissolved silica from solution, as completely oxidized Fe(III) hydrous oxy(hydr)oxides HFOs in ACAIE.

Difference in Mechanisms of Silica Removal Between ACAIE and Fe-EC from X-Ray Photoelectron Spectroscopy

X-ray photoelectron spectroscopy (XPS) was used to investigate the binding energy and the bonding of elements, namely Fe, Si and O. In our case, we use XPS to find the differences in silica bonding with Fe-oxides between Fe-EC and ACAIE, to explain why ACAIE performs better in removing dissolved silica from water than conventional Fe-EC. Higher binding energy implies more Si—Si polymerization versus lower binding energy implying more Si—Fe attachment [28-30]. Si 2s electrons show lower binding energy for ACAIE than Fe-EC, which implies more attachment of dissolved silica to iron (oxyhydr)oxides in ACAIE. In ACAIE, in-situ H₂O₂ increases Fe(II) oxidation rates by nearly 4 orders of magnitude compared to dissolved oxygen in Fe-EC, as found in prior literature[31-33]. Faster reaction times in ACAIE produced smaller Fe-oxide particles, which could account for the improved attachment with dissolved silica to Fe-oxides in ACAIE. The particle size of Fe oxides is smaller in ACAIE is also seen from XRD results, where the peaks are sharper in Fe-EC and broader in ACAIE, the broadening of the peaks is related to the smaller size of particles in ACAIE [34]. The difference in binding energy in both ACAIE and Fe-EC is not significant between 60 and 600 C/L/min dosage rates. The Si 2s spectra evidenced shifts for Fe-EC and ACAIE at 60 and 600 C/L/min (denoted by EC60, EC600, AC 60, and AC600 labels respectively) Other spectra also show similar shifts, which show Si 2p binding energy shift to lower binding energy for ACAIE versus Fe-EC, and similarly explained in prior literature [28]

Mass Balance of Silica Post-Treatment Between Electrode and Unfiltered Solution

The mechanism of silica removal reported in the literature suggests that some of aqueous silica with negatively charged particles go towards the positive iron anode during Fe-EC [35]. To verify such reported mechanism of silica removal, we used 4.11 M HCl acid to wash the electrode right after the electro-coagulation experiment is completed. Next, we diluted the acid wash solution by 1/10 dilution factor, and used ICP-OES to measure the silica attached to the Fe-anode in Fe-EC and ACAIE. Silica in the final unfiltered solution after treatment was also measured using the same ICP-OES. By the conservation of mass principle, the dissolved silica initially present in the solution should be equal to the sum of the silica in the unfiltered solution and attached to the electrode. We repeated the experiment for three replicates for Fe-EC, and ACAIE, for 200 C/L total Fe dose, at two dosage rates of 3 C/L/min (large retention time of 66.66 minutes) and 60 C/L/min (retention time of 3.33 min).

As seen in Table 2, it was found that silica is conserved between the initial level and the sum of silica in the final unfiltered solution added to silica washed from the anode. The results show that the amount of silica attached to the anode is minimal, and most of the silica is remaining in the unfiltered solution. Hence, the dominant mechanism for aqueous silica removal by Fe-EC should be attachment to Fe-oxides and coagulation. Also, the amount of silica going to the electrode is smaller in ACAIE than in Fe-EC for the same charge dosage rate of 60 C/L/min, or 3 C/L/min. Moreover, by visual inspection during our experiments, the silica attachment to the electrodes is very loose. The silica gel-like layer was dislodged from the electrode due to slight vibrations. Table 2 shows that the sum of silica going to electrode post-treatment and remaining in solution post-treatment, is almost equal to the initial silica level of 325-350 mg/L within some experimental errors over repeated runs.

TABLE 2
Conservation of silica from initial 350 mg/L and final silica
post-treatment in unfiltered solution and on the anode.

| | Unfiltered | On anode | Total UF + |
|---|---|---|---|
| | (UF) mg/L | mg/L post | anode |
| | post-treatment | treatment | mg/L |
| ACAIE 60 | 355.3 ± 10.1 | 0.3 ± 0.2 | 355.7 |
| Fe-EC 60 | 323.5 ± 62.5 | 1.4 ± 0.9 | 325.0 |
| ACIAE 3 | 346.4 ± 4.8 | 3.1 ± 1.24 | 349.5 |
| Fe-EC 3 | 340.9 ± 9.4 | 4.7 ± 2.8 | 345.6 |

Iron electrocoagulation (Fe-EC) is an efficient and affordable method for removing contaminants such as arsenic [14, 36]. Fe-EC produces Fe-oxide nanoparticles with Fenton-type reactions, that produces highly sorbent surfaces which can attract and precipitate contaminants [36]. Hence, iron-electrocoagulation has been used for removing silica from wastewater in semiconductor (polishing wastewater) [35], as well as high recovery reverse osmosis (HERO) concentrate [9]. In Fe-EC systems with an iron anode and cathode, oxidation at the sacrificial anode produces Fe(II) from Fe(0). Dissolved oxygen oxidizes the Fe(II) to Fe(III), also called hydrous Ferric oxide (HFO). Contaminants form covalently bonded complexes on the surface of the HFOs, form aggregates and flocs, that coagulates and settles down due to gravity. The duration of this whole process is rate-limited by the amount of dissolved oxygen in the water, which controls the critical Fe(II) to Fe(III) oxidation. Oxygen is generally present in water at ambient conditions at a maximum saturated level based on partial pressure of oxygen. The amount of oxygen is not enough to oxidize large amounts of Fe(II) coming into solution at high charge dosage rates employed to speed up the reaction kinetics in high throughput Fe-EC. Bubbling additional oxygen is not practical for large scale operations of water treatment in the field for long durations of time. Additional consumables (e.g., O₂) also defeat the affordability aspect of Fe-EC utilizing Fe-oxides produced in-situ for large scale water treatment. Thus, conventional Fe-EC limits increasing the throughput of water treatment. Moreover, any attempt to increase reaction kinetics by increasing the current density and charge dosage rates results in the formation of mixed valent Fe-oxides including green rust (GR), which is a poor sorbent for contaminants [17, 27, 37]. To overcome the rate limitations of the conventional Fe-EC process, we introduced an air-diffusion cathode, to have air-cathode assisted iron electrocoagulation or ACAIE. In ACAIE, the iron cathode is replaced by an air-breathing or air-diffusion cathode made of porous carbon felt coated with carbon black on water side and graphite platelets on the air-side. The reaction at the cathode generates hydrogen peroxide (H₂O₂) by the reduction of oxygen at nearly neutral pH (˜7) [22]. H₂O₂ is a stronger oxidant than dissolved oxygen, oxidizes Fe-oxides more efficiently and produces highly sorbent iron-oxides in completely oxidized Fe(III) form, which are more effective in removing dissolved silica from the synthetic high silica content produced water as shown by the results.

We show that air-cathode assisted iron-electrocoagulation have better dissolved silica removal than conventional iron-electrocoagulation in lab-scale experiments. ACAIE in particular is a viable pathway of removing silica from produced water as a high throughput, low-retention time, and low footprint process, which can be used as pre-treatment to prevent fouling of membranes in reverse osmosis. Current estimates for conventional Fe-EC in scaled up process consists of 2000 liter reactors operated in batch mode, whereas ACAIE can be operated in flow through mode.

### REFERENCES

[1] World Health Organization, “Fact-sheet on drinking water,” 2019.
[2] K. R. Zodrow et al., “Advanced materials, technologies, and complex systems analyses: Emerging opportunities to enhance urban water security,” ed: ACS Publications, 2017.
[3] J. J. Urban, “Emerging scientific and engineering opportunities within the water-energy nexus,” Joule, vol. 1, no. 4, pp. 665-688, 2017.
[4] C. Clark and J. Veil, “Produced water volumes and management practices in the United States,” Argonne National Lab.(ANL), Argonne, Ill. (United States) 2009.
[5] K. M. Keranen, et al., “Sharp increase in central Oklahoma seismicity since 2008 induced by massive wastewater injection,” Science, vol. 345, no. 6195, pp. 448-451, 2014.
[6] B. Mi and M. Elimelech, “Silica scaling and scaling reversibility in forward osmosis,” Desalination, vol. 312, pp. 75-81, 2013.
[7] W. Den and C.-J. Wang, “Removal of silica from brackish water by electrocoagulation pretreatment to prevent fouling of reverse osmosis membranes,” Separation and Purification Technology, vol. 59, no. 3, pp. 318-325, 2008.
[8] T. Koo, Y. Lee, and R. Sheikholeslami, “Silica fouling and cleaning of reverse osmosis membranes,” Desalination, vol. 139, no. 1-3, pp. 43-56, 2001.
[9] Y. Chen, J. C. Baygents, and J. Farrell, “Evaluating electrocoagulation and chemical coagulation for removing dissolved silica from high efficiency reverse osmosis (HERO) concentrate solutions,” Journal of water process engineering, vol. 16, pp. 50-55, 2017.
[10] Y. Zeng, C. Yang, W. Pu, and X. Zhang, “Removal of silica from heavy oil wastewater to be reused in a boiler by combining magnesium and zinc compounds with coagulation,” Desalination, vol. 216, no. 1-3, pp. 147-159, 2007.
[11] S. S. Cob et al., “Silica removal to prevent silica scaling in reverse osmosis membranes,” Desalination, vol. 344, pp. 137-143, 2014.
[12] P. comm. “Sandstone reservoirs such as produced water in San Joaquin valley,” 2019.
[13] K. Jepsen, et al. “Membrane fouling for produced water treatment: A review study from a process control perspective,” Water, vol. 10, no. 7, p. 847, 2018.
[14] S. Amrose et al., “Arsenic removal from groundwater using iron electrocoagulation: effect of charge dosage rate,” Journal of Environmental Science and Health, Part A, vol. 48, no. 9, pp. 1019-1030, 2013.
[15] C. M. van Genuchten, S. E. Addy, J. Peña, and A. J. Gadgil, “Removing arsenic from synthetic groundwater with iron electrocoagulation: an Fe and As K-edge EXAFS study,” Environmental science & technology, vol. 46, no. 2, pp. 986-994, 2012.
[16] K.-T. Kin, H.-S. Tang, S.-F. Chan, S. Raghavan, and S. Martinez, “Treatment of chemical-mechanical planarization wastes by electrocoagulation/electro-Fenton method,” IEEE transactions on semiconductor manufacturing, vol. 19, no. 2, pp. 208-215, 2006.
[17] C. M. van Genuchten, S. R. Bandaru, E. Surorova, S. E. Amrose, A. J. Gadgil, and J. Pena, “Formation of macroscopic surface layers on Fe (0) electrocoagulation electrodes during an extended field trial of arsenic treatment,” Chemosphere, vol. 153, pp. 270-279, 2016.
[18] K. Lee and J. Neff, Produced water: environmental risks and advances in mitigation technologies. Springer, 2011.
[19] R. Funston, R. Ganesh, and L. Y. Leong, “Evaluation of technical and economic feasibility of treating oilfield produced water to create a “new” water resource,” in Ground Water Protection Council (GWPC) Meeting, 2002.
[20] S. Jiménez, M. Micó, M. Arnaldos, F. Medina, and S. Contreras, “State of the art of produced water treatment,” Chemosphere, vol. 192, pp. 186-208, 2018.
[21] C. van Genuchten, T. Behrends, P. Kraal, S. L. Stipp, and K. Dideriksen, “Controls on the formation of Fe (II, III)(hydr) oxides by Fe (0) electrolysis,” Electrochimica Acta, vol. 286, pp. 324-338, 2018.
[22] J. M. Barazesh, T. Hennebel, J. T. Jasper, and D. L. Sedlak, “Modular advanced oxidation process enabled by cathodic hydrogen peroxide production,” Environmental science & technology, vol. 49, no. 12, pp. 7391-7399, 2015.
[23] C. Ruby et al., “Synthesis and transformation of iron-based layered double hydroxides,” Applied clay science, vol. 48, no. 1-2, pp. 195-202, 2010.
[24] A. Liu, J. Liu, B. Pan, and W.-x. Zhang, “Formation of lepidocrocite (γ-FeOOH) from oxidation of nanoscale zero-valent iron (nZVI) in oxygenated water,” Rsc Advances, vol. 4, no. 101, pp. 57377-57382, 2014.
[25] R. T. Downs and M. Hall-Wallace, “The American Mineralogist crystal structure database,” American Mineralogist, vol. 88, no. 1, pp. 247-250, 2003.
[26] C. Su and R. T. Wilkin, “Arsenate and arsenite sorption on and arsenite oxidation by iron (II, III) hydroxycarbonate green rust,” ACS Publications, 2005.
[27] C. M. van Genuchten, J. Peña, S. E. Amrose, and A. J. Gadgil, “Structure of Fe (III) precipitates generated by the electrolytic dissolution of Fe (0) in the presence of groundwater ions,” Geochimica et Cosmochimica Acta, vol. 127, pp. 285-304, 2014.
[28] P. J. Swedlund, S. Sivaloganathan, G. M. Miskelly, and G. I. Waterhouse, “Assessing the role of silicate polymerization on metal oxyhydroxide surfaces using X-ray photoelectron spectroscopy,” Chemical Geology, vol. 285, no. 1-4, pp. 62-69, 2011.
[29] Y. Song, P. J. Swedlund, C. Zou, and R. D. Hamid, “The influence of surface structure on H4SiO4 sorption and oligomerization on goethite surfaces: An XPS study using goethites differing in morphology,” Chemical Geology, vol. 347, pp. 114-122, 2013.
[30] P. J. Swedlund, H. Holtkamp, Y. Song, and C. J. Daughney, “Arsenate-ferrihydrite systems from minutes to months: a macroscopic and IR spectroscopic study of an elusive equilibrium,” Environmental science & technology, vol. 48, no. 5, pp. 2759-2765, 2014.
[31] S. J. Hug and O. Leupin, “Iron-catalyzed oxidation of arsenic (III) by oxygen and by hydrogen peroxide: pH-dependent formation of oxidants in the Fenton reaction,” Environmental science & technology, vol. 37, no. 12, pp. 2734-2742, 2003.
[32] D. King and R. Farlow, “Role of carbonate speciation on the oxidation of Fe (II) by H2O2,” Marine Chemistry, vol. 70, no. 1-3, pp. 201-209, 2000.
[33] D. W. King, “Role of carbonate speciation on the oxidation rate of Fe (II) in aquatic systems,” Environmental Science & Technology, vol. 32, no. 19, pp. 2997-3003, 1998.
[34] K. Eusterhues et al., “Characterization of ferrihydrite-soil organic matter coprecipitates by X-ray diffraction and Mossbauer spectroscopy,” Environmental science & technology, vol. 42, no. 21, pp. 7891-7897, 2008.
[35] W. Den, C. Huang, and H.-C. Ke, “Mechanistic study on the continuous flow electrocoagulation of silica nanoparticles from polishing wastewater,” Industrial & engineering chemistry research, vol. 45, no. 10, pp. 3644-3651, 2006.
[36] C. Delaire, et al., “How do operating conditions affect As (III) removal by iron electrocoagulation?,” Water research, vol. 112, pp. 185-194, 2017.
[37] S. Müller, T. Behrends, et al., “Sustaining efficient production of aqueous iron during repeated operation of Fe (0)-electrocoagulation,” Water research, vol. 155, pp. 455-464, 2019.

III. High Performance Electrochemical Arsenic Removal Using External Oxidizer

Our previously disclosed ECAR technology teaches effective and efficient removal of arsenic using iron electrocoagulation. Although that technology is successful in the field, it has limitations, e.g. (1) ECAR consumes dissolved oxygen during its operation which must be replaced by natural dissolution of atmospheric oxygen for successful functioning. his dissolution is a slow process. If ECAR is pushed with higher charge dosage rate (C/L/min) than can be sustained by the rate of atmospheric oxygen dissolution, it leads to undesirable formation of green rust which is ineffective in capturing arsenic; and (2) as previously implemented, ECAR requires high manual maintenance and is therefore cumbersome and prohibitively expensive in places with high labor costs.

The present invention overcomes both these limitations of ECAR technology by adding an external oxidizer (e.g. H₂O₂) in minute quantities to the raw water. This allows for much higher water throughput for a given reactor size, absence of limitations posed by dissolved oxygen replenishment, and low labor costs owing to much lower manual maintenance requirements of the iron anodes.

A strong oxidizing agent (such as: H₂O₂, O₃ (ozone), KMnO₄ (permanganate), K₂Cr₂O₇, etc.) is added to the raw arsenic bearing water, at a concentration equivalent (in electron transfer capacity) to at least 1 mg/L of H₂O₂. It is then (first dissolved if needed) and mixed with the raw water. Iron electrocoagulation is then carried out at a high current density (2.5-100 mA/cm2), and correspondingly high charge dosage rate. These process conditions ensure a very short residence time of water being treated in the reactor which facilitates higher throughput. Post electrolysis, arsenic is adsorbed onto the iron oxyhydroxide flocs, and can then be removed (e.g., by gravity settling or membrane/ceramic filtration). It is a novel process because it has not been practiced until now, it is not in any published literature, and is not known those skilled in the relevant arts. This process overcomes the previous limitations posed by slow dissolution rate of atmospheric oxygen, and can now produce arsenic-safe water at much higher flow rates, than what was possible with conventional ECAR. The operating parameters ensure minimal manual maintenance of iron electrodes, as they no longer require frequent manual cleaning for successful long-term operation.

The present technology provides numerous advantages over existing methods:

1. Better arsenic removal performance at high current density and high charge dosage rate; 2. Lower cost and smaller space requirements; 3. Facilitates high water throughput as desirable by industries; 4. Minimal manual maintenance of the iron electrodes; 5. Greater reliability; 6. This is a ZLD (Zero Liquid Discharge) technology, which is now favored by water-conserving practitioners.

Applications of this invention include: to provide arsenic safe drinking water at high flow rates with minimal manual maintenance. Any company which needs arsenic-safe groundwater, especially in the state of California, is potential user. Examples include wineries which use arsenic-bearing groundwater to water their vines or provide drinking water to workers and customers; public utilities that rely on groundwater to provide safe drinking water, coal fired power plants, that need to treat ash-pond water; and companies that aim to sell arsenic-safe treated groundwater for drinking in arsenic-affected areas

Example: A novel energy efficient design of iron electrocoagulation with externally added H2O2 to remove arsenic in the groundwater used for drinking.

Air Cathode assisted iron electrocoagulation (ACAIE) efficiently remove arsenic from 300-1500 μg/L to less than 10 μg/L at short treatment times (˜minutes) (Bandaru et al., 2020). Rapid oxidation kinetics of the anodically generated Fe(II) and cathodically generated H₂O₂ produces higher yields of selective (e.g., Fe(IV)) and non-selective oxidants (e.g., OH radical) to oxidize efficiently all As(III) to As(V), which adsorbs rapidly onto freshly generated Fe(III)(oxyhydr)oxides. These unique properties allow ACAIE to operate at extremely short retention times (˜seconds) or high throughput volumes without compromising the arsenic removal performance. Short retention time requires large currents (>5 A) to produce desired amounts of Fe(II) and H₂O₂ to remove arsenic to less than 10 ppb consistently. Our work on arsenic removal in synthetic Bangladesh groundwater using ACAIE at short treatment times (1 min), show significant operating potentials (>40 V) between the electrodes. Cell potentials must be less than <40 V for safe operation of ACAIE systems in the field. Low operating voltages (<20 V) at high currents (>10 A) could be achieved by reducing the spacing between electrode plates and increasing the surface area of the electrodes. However, small electrode spacing and large cathode surface areas (>1000 cm²) are yet to be investigated in ACAIE. The large operating cell voltages in these systems was due to the small electrode surface area to volume (<1000 cm²/L) and moderate interelectrode distance (on the order of 2 to 10 cm). Typically, ohmic drop and overpotentials contribute significantly to the high cell voltages at high current densities (Newman & Thomas-Alyea, 2004). Operating cell voltages can be decreased significantly with high surface area to volume (>2000 cm²/L) and small interelectrode distance (about 0.2 cm). Hence, innovative designs of ACAIE and FeEC should be explored to address the limitations of high cell voltages. One such FeEC design is the utilization of thin sheets of low carbon steel with non-conducting nylon meshes rolled in the form of a spiral configuration. This configuration allows high surface area to volume (>2000 cm^{Z}/L) and small interelectrode distance (about 0.2 cm). Further, rapid removal rates of the contaminants can be achieved with the addition of an external oxidizers such as H₂O₂, HOCI etc., to the influent of FeEC systems. Thus, similar performance as ACAIE can be achieved at low energy costs and nearly 20-fold reduction in the space footprint.

In this work, we evaluated the arsenic removal in FeEC with external H₂O₂ using conventional parallel plate electrode configurations in bench scale (0.5 L) batch experiments to understand the removal efficiencies relative to the published results of ACAIE. Further, the arsenic removal investigated with novel configuration of spiral FeEC reactor in continuous flow mode. Finally, cell resistance (voltage/current) was monitored over 2 hours in small scale (0.5 L) spiral FeEC reactor to understand if cell resistance can be used to identify the time for Fe(0) electrode replacement.

Bench scale FeEC experiments with external H₂O₂ of 3.1 mM were performed in SBGW (pH 7, initial As(III) of 1550 μg/L) electrolyte at various electrolysis times (mins) or charge dosage rates (C/L/min) using SBGW electrolyte (the initial As(III) of 1550 μg/L). The total charge dosage of 600 C/L was maintained at each charge dosage rate. These bench scale experiments were performed to evaluate the arsenic removal of with respect to the published results of ACAIE in Bandaru et. al., 2020. Arsenic remaining in the treated water was always below the WHO-Maximum Contaminant Level (WHO-MCL) of 10 μg/L at all charge dosage rates. Also, the dissolved iron remaining in the treated water was also lower than WHO-Secondary MCL (WHO-SMCL) of 0.3 mg/L, which confirm the absence of any dissolved iron due to incomplete oxidation. These results were consistent with the published results of ACAIE. Therefore, the arsenic removal like ACAIE can be achieved by FeEC with external oxidizers (e.g., H₂O₂, HOCI, Ozone, KMnO₄ etc.) which oxidize Fe(II) at faster rates than the dissolved oxygen.

Further, FeEC-H₂O₂ with novel electrochemical spiral design was also investigated. This novel design consists of thin sheets of steel plates (0.007 inches thick) and non-conducting plastic meshes rolled in a spiral form and entire assembly inserted in cylindrical containers. Herein this design will be referred as spiral reactor or spiral design. This unique configuration maintains small electrode spacing (0.2-0.3 cm) and high electrode surface area to volume ratios. We found improved performance of spiral reactor (see Table 1) with external H₂O₂ of 1.6 mM (equivalent coulombic dose is 300 C/L) for removing initial As(III) of 300 μg/L in synthetic groundwater matrix. In each experiment of spiral reactor, 100 L of the synthetic Bangladesh groundwater (Initial As(III) 300 μg/L) was prepared using tap water according to the protocols published in the literature. The pH of the groundwater was adjusted to 7 by bubbling CO_{2(g)}. In each experiment, 100 L of the synthetic groundwater was pumped using a submersible pump (0.1 HP) and electrolysis begun after reactor was filled with the groundwater. Experiment was stopped after all the 100 L groundwater was treated after 8 minutes. Experimental conditions and arsenic removal were summarized in Table 1. The dissolved arsenic in the treated water was consistently lower than the WHO-MCL in spiral FeEC reactor with external H₂O₂.

Further, bench scale experiments with spiral FeEC systems (reactor volume ˜0.5 L) with external oxidizer (H₂O₂) to investigate the rapid increase in cell resistance, when near complete anodic dissolution of the Fe(0) electrodes occur. These experiments were performed to identify desired times for Fe(0) electrode replacement. Cell current and cell voltage were monitored continuously during the experiment over 2 hours. The cell resistance estimated from voltage and current was plotted with time. A steep increase in the cell resistance was observed after 90 minutes of electrolysis which could be due to near complete dissolution of anode plates. These results confirm the ability of continuous monitoring of cell resistance as a performance indicator to track the life of the Fe(0) electrodes.

TABLE 1
Summary of the experimental parameters, arsenic removal, and electrical
energy per order of magnitude removal of spiral reactor with reactor volume of 4.65 L.

| | Submerged | | | | | | | | Electrical |
|---|---|---|---|---|---|---|---|---|---|
| Spacing | surface area | | | Current | | Dosage | Total | | energy |
| between | of each | Retention | Flow | Density | | Rate | arsenic | | per order |
| electrodes | electrode | time | rate | (mA/ | Dosage | (C/L/ | (μg/L) | | (kWh |
| (cm) | (cm²) | (seconds) | (LPH) | cm²) | (C/L) | min) | Initial | Final | m⁻³ log⁻¹) |
| 0.20 | 5194 | 23 | 713 | 12 | 303 | 774 | 335 | 2.4 | 0.3 |

### References

Amrose, et al. (2014). Electro-chemical arsenic remediation: field trials in West Bengal. Science of the Total Environment, 488-489, 539-546.
Amrose, et al. (2013). Arsenic removal from groundwater using iron electrocoagulation: Effect of charge dosage rate. Journal of Environmental Science and Health Part a-Toxic/Hazardous Substances & Environmental Engineering, 48(9), 1019-1030.
Balazs, et al. (2012). Environmental justice implications of arsenic contamination in California's San Joaquin Valley: a cross-sectional, cluster-design examining exposure and compliance in community drinking water systems. Environmental Health, 11(1), 84.
Bandaru, et al. (2020). Rapid and Efficient Arsenic Removal by Iron Electrocoagulation Enabled with in Situ Generation of Hydrogen Peroxide. Environmental Science & Technology, 54(10), 6094-6103.
Chaplin, B. P. (2018). Advantages, Disadvantages, and Future Challenges of the Use of Electrochemical Technologies for Water and Wastewater Treatment. Electrochemical Water and Wastewater Treatment, 451-494.
Chaplin, B. P. (2019). The Prospect of Electrochemical Technologies Advancing Worldwide Water Treatment. Accounts of Chemical Research, 52(3), 596-604.
Delaire, C., Amrose, S., Zhang, M., Hake, J., & Gadgil, A. (2017). How do operating conditions affect As(III) removal by iron electrocoagulation? Water Research, 112, 185-194.
Dubrawski, et al. (2015). Production and Transformation of Mixed-Valent Nanoparticles Generated by Fe(0) Electrocoagulation. Environmental Science & Technology, 49(4), 2171-2179.
Hernandez, et al. (2019). Strategies for successful field deployment in a resource-poor region: Arsenic remediation technology for drinking water. Development Engineering, 4, 100045.
Johnston, R. B., Hanchett, S., & Khan, M. H. (2010). The socio-economics of arsenic removal. Nature Geoscience, 3(1), 2-3.
Newman, J. S., & Thomas-Alyea, K. E. (2004). Electrochemical systems (3rd ed.). Hoboken, N.J.: Wiley-Interscience.
Podgorski, J., & Berg, M. (2020). Global threat of arsenic in groundwater. Science, 368(6493), 845-850.
Qian, A., Yuan, S. H., Xie, S. W., Tong, M., Zhang, P., & Zheng, Y. S. (2019). Oxidizing Capacity of Iron Electrocoagulation Systems for Refractory Organic Contaminant Transformation. Environmental Science & Technology, 53(21), 12629-12638.
Radjenovic, J., & Sedlak, D. L. (2015). Challenges and Opportunities for Electrochemical Processes as Next-Generation Technologies for the Treatment of Contaminated Water. Environmental Science & Technology, 49(19), 11292-11302.
Smith, et al. (1992). Cancer risks from arsenic in drinking water. Environ Health Perspect, 97, 259-267.
Smith, A. H., Lopipero, P. A., Bates, M. N., & Steinmaus, C. M. (2002). Public health—Arsenic epidemiology and drinking water standards. Science, 296(5576), 2145-2146.
Steinmaus, et al. (2013). Drinking water arsenic in northern chile: high cancer risks 40 years after exposure cessation. Cancer Epidemiol Biomarkers Prev, 22(4), 623-630.

1. A high performance iron electrocoagulation (Fe-EC) reactor for removing water contaminants comprising an assembly of spiral-wound or folded and inter-digited iron-containing anode and cathode plates separated with perforated insulating spacers.

2. The reactor of claim 1, wherein:
one or both plates comprise steel;
the reactor contains contaminated water and an oxidant selected from H₂O₂, O₃, chlorine, and permanganate;
the reactor is contained in a cylindrical tank, of circular cross-section for the spiral wound reactor,
the reactor comprises a perforated insulating sheet or mesh separator disposed between the plates;
the reactor comprises a 4-layer, spiral-wound assembly of electrode plate, first perforated insulating sheet or mesh separator, opposite electrode plate, second perforated insulating sheet or mesh separator, and/or
the water is contaminated with an organic contaminant (e.g., pharmaceuticals, organic pesticides), ions of a metal (such as arsenic, heavy chromium, copper, manganese, nickel, cadmium, uranium, cobalt, and lead), a phosphate, a silicate (e.g. silicate minerals, ionic solids with silicate anions; as well as rock types that comprise predominantly such minerals, such as the non-ionic compound silicon dioxide SiO₂, e.g. silica, quartz)), hexavalent chromium (this uses the same reactor design, but without adding external oxidizer).

3. The reactor of claim 1, contained in a tank wherein:
the plates are electrically connected to a DC voltage source,
a DC voltage exists between the plates,
the reactor contains contaminated water; and
the tank has an inlet or inlets and an outlet or outlets, configured in a flow path to flow contaminated water through the inlet or inlets, pass through the space between the plates, and exit the tank from the outlet or outlets,
wherein the contaminated water is non-stationary within the tank, and in motion or flowing.

4. A method of using the reactor of claim 1, comprising applying a DC voltage between the plates to promote anodic dissolution of F(0) metal to release Fe(II) ions into the contaminated water, which optionally further comprises the steps of tracking changes in voltage and/or current over time to monitor degradation of electrode plates, and replacing one or both of the plates.

5. A method for arsenic removal from water comprising:
flowing arsenic-contaminated water through an iron electrocoagulation (Fe-EC) reactor comprising an anode, a cathode and an oxidant sufficient to accelerate oxidation of Fe(II) ions released from the anode to obtain Fe(III) ions, and/or to oxidize arsenic in the water, and
applying a DC voltage between the anode and cathode to promote anodic dissolution of F(0) metal to release Fe(II) ions into the contaminated water, wherein the arsenic is removed from the water in the reactor.

6. The method of claim 5:
achieving effective removal of arsenic from initial level of at least or about 10 or 100 fold, such as from >100 to <10 μg/L or >1000 μg/L to <100, e.g. 200-2,000 to 2-20 μg/L;
using a flow rate of at least about, or about 2 or 3 or 4 times the reactor volume per minute, or a range of about 2 or 3 or 4 to about 4 or 6 or 8 times the reactor volume per minute, e.g. in a reactor size of 0.5 liters we achieved this removal in 15 seconds, giving a flow rate of 4 times the reactor volume per minute; or
using high current density of at least about, or about 2.5, 5, 10, 20, 40, 80 or 200 mA/cm square, or a range of 2.5 or 20 or 40 or 80 to 80 or 120 or 200 mA/cm square.

7. The method of claim 5 wherein the oxidant is H₂O₂, O₃, KMnO₄ (permanganate), or K₂Cr₂O₇.

8. The method of claim 5 wherein the oxidant is H₂O₂, and is generated in-situ, rather than added exogenously.

9. The method of claim 5, wherein the reactor is contained in a tank wherein:
the anode and cathode are electrically connected to a DC voltage source,
a DC voltage exists between the anode and cathode, and
the reactor contains the contaminated water and Fe(II) ions released from the F(0) of the anode, wherein the tank has an inlet or inlets and an outlet or outlets, configured in a flow path to flow contaminated water through the inlet or inlets, pass through the space between the anode and cathode, and exit the tank from the outlet or outlets.

10. The method of claim 5, wherein:
the reactor comprises a perforated insulating sheet or mesh separator disposed between the anode and cathode.
the reactor is an air-cathode assisted iron-electrocoagulation (ACAIE) reactor comprising an air-diffusion cathode.
the reactor is a high performance iron electrocoagulation (Fe-EC) reactor comprising an assembly of spiral-wound or folded and inter-digited iron-containing anode and cathode plates separated with perforated insulating spacers.

11. The method of claim 5, further comprises the steps of tracking changes in voltage and/or current over time to monitor the degradation of an electrode, and replacing one or both of the anode and cathode or replacing the assembly.

12. The method of claim 5, wherein the separating step comprises separating the contaminated water or aqueous solution comprising the Fe(III) precipitates or Fe(II)-Fe(III) precipitates or Iron(III)(oxyhydr)oxides using a separation technique (such as filtration, coagulation, flocculation, settling or any combination of these techniques) to achieve clearer water.

13. A method for silica removal from water comprising:
flowing silica-contaminated water through an iron electrocoagulation (Fe-EC) reactor comprising an anode, a cathode, and an oxidant sufficient to accelerate oxidation of Fe(II) ions released from the anode to obtain Fe(III) ions; and
applying a DC voltage between the anode and cathode to promote anodic dissolution of F(0) metal to release Fe(II) ions into the contaminated water, wherein the silica is removed from the water in the reactor.

14. The method of claim 13:
achieving effective removal of silica from initial level of at least or about 5 or 10 fold, such as from 100-500 mg/L to 20-100 or 10-50 mg/L, e.g. 350 mg/L to 30 mg/L;
using a flow rate of at least about, or about 2 or 3 or 4 times the reactor volume per minute, or a range of about 2 or 3 or 4 to about 4 or 6 or 8 times the reactor volume per minute, e.g. in a reactor size of 0.5 liters we achieved this removal in 15 seconds, giving a flow rate of 4 times the reactor volume per minute;
using high current density of at least about, or about 20, 40, 80 or 200 mA/cm square, or a range of 20 or 40 or 80 to 80 or 120 or 200 mA/cm square.

15. The method of claim 13 wherein the oxidant is H₂O₂, O₃, chlorine, or permanganate.

16. The method of claim 13 wherein the oxidant is H₂O₂, and is generated in-situ, rather than added exogenously.

17. The method of claim 13, wherein the reactor is contained in a tank wherein:
the anode and cathode are electrically connected to a DC voltage source,
a DC voltage exists between the anode and cathode, and
the reactor contains the contaminated water and Fe(II) ions released from the F(0) of the anode,
wherein the tank has an inlet or inlets and an outlet or outlets, configured in a flow path to flow contaminated water through the inlet or inlets, pass through the space between the anode and cathode, and exit the tank from the outlet or outlets.

18. The method of claim 13, wherein:
the reactor comprises a perforated insulating sheet or mesh separator disposed between the anode and cathode;
the reactor is an air-cathode assisted iron-electrocoagulation (ACAIE) reactor comprising an air-diffusion cathode; or
the reactor is a high performance iron electrocoagulation (Fe-EC) reactor comprising an assembly of spiral-wound or folded and inter-digited iron-containing anode and cathode plates separated with perforated insulating spacers.

19. The method of claim 13, further comprises the steps of tracking changes in voltage and/or current over time to monitor the degradation of an electrode, and replacing one or both of the anode and cathode or replacing the assembly.

20. The method of claim 13, wherein the separating step comprises separating the contaminated water or aqueous solution comprising the Fe(III) precipitates or Fe(II)-Fe(III) precipitates or Iron(III)(oxyhydr)oxides using a separation technique (such as filtration, coagulation, flocculation, settling or any combination of these techniques) to achieve clearer water.
